(19) United States
(12) Patent Application Publication
(10) Pub. No.: US 2002/0020491 A1
(43) Pub. Date: Feb. 21, 2002

(54) High speed flip chip assembly process

(76) Inventors: David M. Price, Mendon, MA (US); Christopher J. Piacitelli, Cranston, RI (US); Gary R. Larson, Cumberland, RI (US); Shaun Huot, Providence, RI (US); James S. Hammond, Scituate, RI (US); Miaoyong Cao, Warwick, RI (US); Bruce P. Mahan, Franklin, MA (US); John G. Wistey, Warwick, RI (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/826,382

(22) Filed: Apr. 4, 2001

Related U.S. Application Data
(60) Provisional application No. 60/194,531, filed on Apr. 4, 2000.

(51) Int. Cl. B32B 31/26

(52) U.S. Cl. 156/307.1

(57) ABSTRACT

A method is provided to assemble flip chips to an electronic circuit using a printable anisotropic conductive adhesive or paste. The invention is especially useful to assemble flip chips or other components to an array of circuits provided within a large area format. The circuits in a preferred embodiment are disposable radio frequency identification devices (RFID) or Smart Cards.

### CROSS REFERENCE TO RELATED APPLICATIONS

Priority is claimed under 35 U.S.C. 119(e) of U.S. Provisional Application No. 60/194,531, filed on Apr. 4, 2000, entitled: METHOD FOR HIGH SPEED FLIP CHIP ASSEMBLY USING ANISOTROPIC ADHESIVE, the disclosure of which is incorporated by reference herein.

### STATEMENT REGARDING FEDERALLY SPONSORED RESEARCH OR DEVELOPMENT

N/A

### BACKGROUND OF THE INVENTION

Flip Chip Assembly techniques allow an integrated circuit (IC) chip or die to be attached directly to an electronic circuit. Typically the die contains a “bump” at each point to be connected to the electronic circuit, usually called Input/Output or “I/O” points. Flip Chip assembly technology has typically focused on expensive die containing a large number of I/O, and as such, emphasizes precision over cost or speed.

The traditional flip chip approach employs a metallic joining material (e.g., solder paste) to connect the bumps to the contact points on the electronic circuit, followed by the application of an “underfill” polymer to enhance the mechanical connection between the chip and circuit substrate. While this approach provides good reliability, it has several drawbacks. It is expensive due to the extensive number of process steps—apply solder paste, place component, reflow solder paste, dispense underfill, cure underfill, dispense encapsulate (optional), cure encapsulate (optional). Because solder paste is typically cured at temperatures in excess of 200 C, this method is not compatible with low cost, low temperature substrates such as polyester, polyvinyl chloride and polyethylene.

Another approach employs an Isotropic Conductive Adhesive (ICA) in place of solder paste. While ICA's, such as silver filled epoxies, generally cure at lower temperatures compatible with the aforementioned low cost, low temperature substrates, they still require the use of an underfill, adding process steps and costs.

Yet another approach employs an Anisotropic Conductive Adhesive (ACA) as both a electrical joining material (in lieu of solder paste or ICA) and a mechanical attachment material (in lieu of underfill). ACA materials employ conductive spheres in a polymer matrix such that there is connection only in the Z-axis, and hence can be referred to as “Z-axis Adhesives”. The ACA approach is lower cost due to reduced process steps and is compatible with low cost, low temperature substrates. Typically the ACA is applied in a film format known as Anisotropic Conductive Film (ACF). The film is cut and applied to the electronic circuit. The chip is then placed onto the ACF and then bonded. Some approaches cure the ACF with a pick and place machine in which the pick and place head applies heat, pressure and/or ultrasonic energy to cure the ACF. In other cases, a separate bonding operation is employed.

The traditional ACF approach has several drawbacks. The electronic circuit substrate format is typically a narrow web (35 or 70 mm wide), permitting only one circuit to be placed across the width of the substrate. The ACF must be cut and applied in a serial fashion to the location where the die is to be attached. Increasing speed requires the use of multiple ACF dispensers. Changing the “layout”, that is, the position of the die on the substrate according to the design of the specific product, requires repositioning of the ACF dispensers. Pick and place units are normally slow, running at less than 3,000 components per hour. Often, the pick & place equipment is limited in the size of the substrate and the position of the die on that substrate. The ACF material requires a long cure time, which also limits the process throughput. In short, the process is slow and inflexible.

A relatively new class of disposable electronic circuits such as Radio Frequency Identification (RFID) transponders and Smart Cards demand very low costs and high manufacturing capacities. The previously mentioned methods are too costly, too slow or too inflexible to meet the demands of these and similar products and markets.

### BRIEF SUMMARY OF THE INVENTION

In brief the present invention provides a method to assemble flip chips to an electronic circuit at very fast speeds and at low cost using a printable Anisotropic Conductive Adhesive or call Anisotropic Conductive Paste (ACP). The invention is especially useful to assemble flip chips and many other types of components to an array of circuits provided within a large area format. In some applications, a Non-Conductive adhesive Paste (NCP) can be used. The circuits in a preferred embodiment are disposable Radio Frequency Identification devices (RFID) or Smart Cards which must be economically produced at fast through-put rates to suit the commercial expectations of low cost and high volumes while still achieving high performance and reliability.

According to one aspect of the invention, an array of flat antenna coils is provided on a substrate sheet. The coils can be formed by printing with a conductive ink or by etching of a copper or other metalized surface of the substrate. An insulator is printed over a crossover area of the coil turns using a dielectric ink and a crossover conductor is printed over the insulator area between the end of the outer coil turn and the inner bonding area. The end of the inner coil turn also terminates at the inner bonding area. The bonding area of each antenna coil is configured to receive a flip chip device thereon. A thermosetting or thermoplastic Anisotropic Conductive Paste is printed onto each of the bonding areas of the array of coils. Chips are then placed on the respective bonding areas on the previously applied Anisotropic Conductive Paste. The substrate with the placed chips is loaded in a bonding press which imparts, over a predetermined duration, predetermined pressure and temperature to the chips to cure the conductive paste and bond the chips in position. The assembly process can be used with a variety of circuits or circuit patterns and provides a throughput which is substantially faster than that achievable by conventional assembly processes.

The novel method is very flexible and a wide variety of circuit formats can be produced. Tooling costs are relatively low and change over between product is very quick, thus achieving intended flexibility and reducing overall production costs. Almost any pattern can be printed with the ACP by changing the stencil design, which is not possible with ACF processing. Flip chip assembly units are often designed to place the component or die in the same location each time. As a result, change-over between products may be impossible or difficult. The present invention uses a pick and place system that can place die anywhere within the work area according to a software program and thus changing products is a mere matter of a change in the software program. Each product has a tool designed for the specific die locations within the work area. The tooling is not expensive and change-over between products is very rapid. Prior thermo-compression units do not have this flexibility.

### BRIEF DESCRIPTION OF THE SEVERAL VIEWS OF THE DRAWING

The invention will be more fully described in the following detailed description taken in conjunction with the accompanying drawings in which:

FIG. 1 is a plan view of an antenna coil processed in accordance with the invention;

FIG. 2 is a diagrammatic plan view of a substrate having an array of antenna coils;

FIG. 3 is a block diagram of the process for forming the antenna coil of FIG. 1;

FIG. 4 is a flow chart of the flip chip assembly process in accordance with the invention;

FIG. 5 is a plan view of an etched copper film antenna coil processed in accordance with the invention;

FIG. 6 is a diagrammatic plan view of a substrate having an array of smaller format 2×2 inch antenna designs; and

FIG. 7 is a diagrammatic plan view of a substrate having an array of 400 circuits per image group.

### DETAILED DESCRIPTION OF THE INVENTION

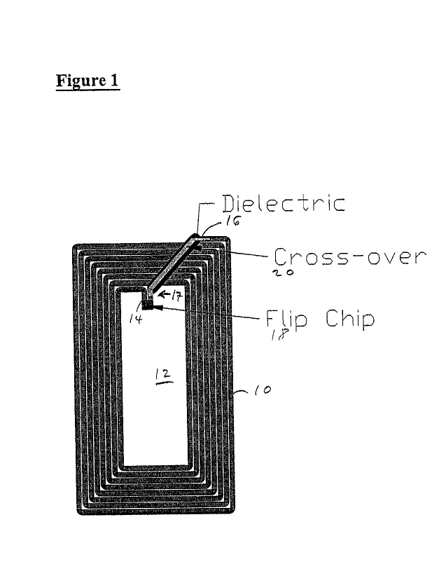

A circuit is shown in FIG. 1 which is produced in accordance with the invention. The circuit is a Radio Frequency Identification transponder or tag composed of a flat multiple turn antenna coil 10 formed on a substrate 12 and having an inner coil end 14 and an outer coil end 16 terminating at a bonding area 17 onto which a circuit chip 18 is attached. An insulating layer 20 is provided over the coil turns in the region where the outer turn crosses over the other turns to the bonding area where the chip is attached. This tag circuit is itself known, and is fabricated in an improved manner in accordance with the present process. In a typical embodiment, the antenna coil has outside dimensions of about 1.8×3 inches. The chip is about 1.5 mm square, 150 micron thick, with two plated gold bumps positioned at diagnoal corners of the die.

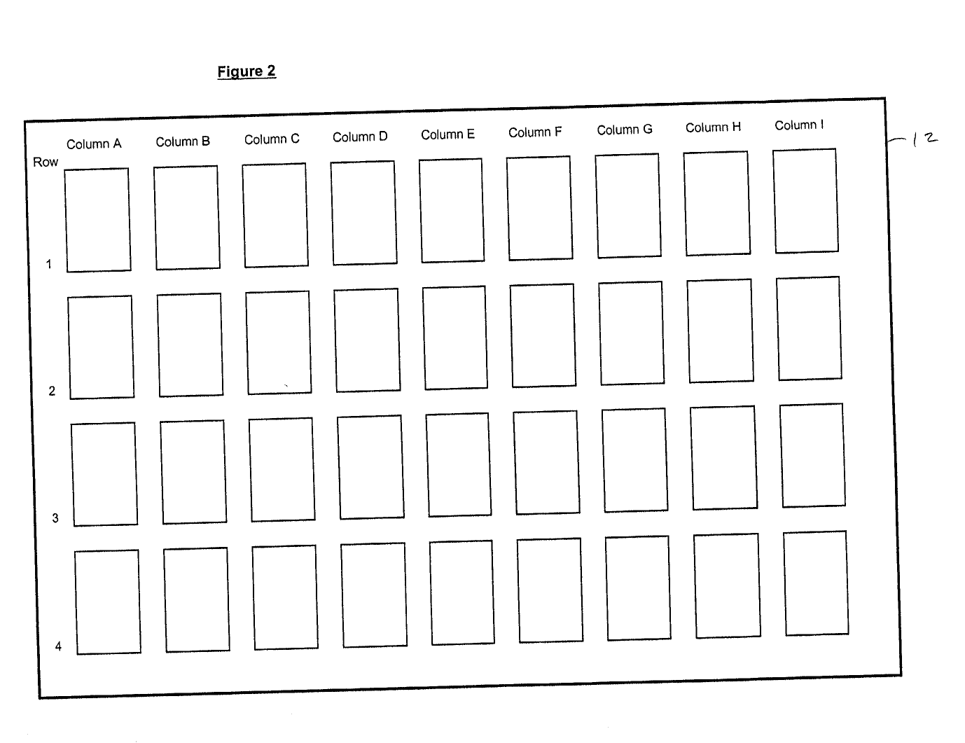

The antenna coils are formed in an array on a common substrate, as shown in FIG. 2. In a preferred layout, 36 of 1.8×3.0 inch coils 10 are formed in a 4 by 8 pattern on a substrate sheet 12 which is 18 by 24 inches. The number of circuits to be processed at one time on the substrate, in this case 36 is called an “image group”. The substrate is typically a polyester (PET) material having a 50 micron thickness.

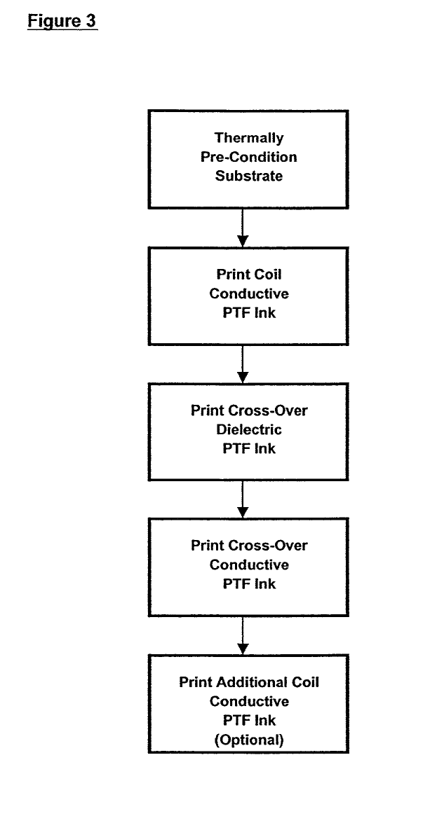

The process for fabricating the antenna coils is depicted in the flow chart of FIG. 3. The coil is printed using silver Polymer Thick Film (PTF) conductive ink. The insulator in the crossover area is printed using dielectric PTF ink, and a second path of insulating material may be printed in the crossover area using dielectric PTF ink to provide intended dielectric thickness. Next the crossover conductor is printed over the insulator area between the end of the outer coil turn and the inner bonding area. A second printing of the coil turns using silver PTF ink is then performed. Depending on the intended circuit performance, a total of one to three coil printing passes may be used. All 36 of the antenna coils are fabricated as an array on the single substrate sheet.

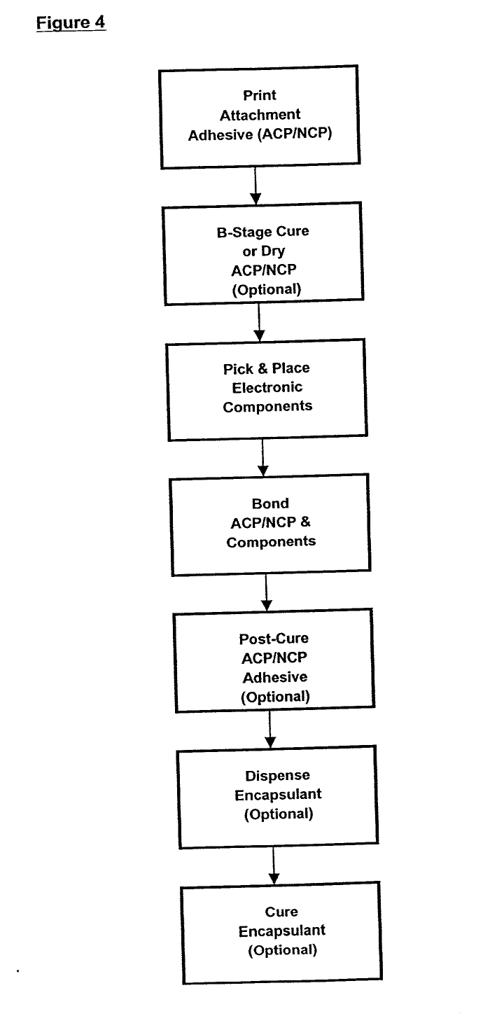

The flip chip assembly process is depicted in the flow chart of FIG. 4. The substrate containing the 36 antenna coils is loaded into a stencil printing press and an Anisotropic Conductive Paste is printed onto the chip locations. The paste is typically applied using a 2 mil stencil and a metal squeegee blade, and is applied at the same time to all of the bonding areas of the chip locations.

The substrate is then moved to a pick and place assembly machine and the chips are placed on the respective bonding areas on the previously applied Anisotropic Conductive Paste. Preferably the 36 chips are placed in a single pass from the pick and place machine onto the respective 36 bonding areas of the substrate sheet before transferring to the bonding operation. The substrate is then loaded into a Z axis bonding press which imparts a predetermined pressure and temperature to the chips, for a predetermined duration. Following bonding the substrate is placed in a curing oven and cured for approximately 10 minutes at 135° C. This post cure step fully cures the conductive paste and is optional depending on the material.

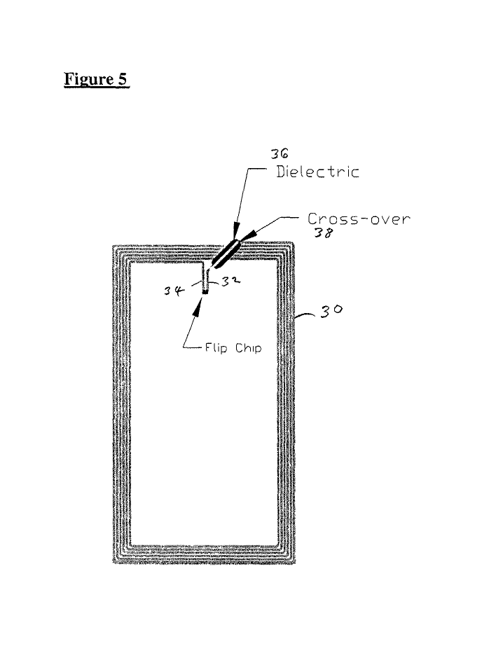

The assembly process can also be employed in assembling flip chips to an etched copper film antenna coil. Such an antenna is shown in FIG. 5 and includes an etched copper coil 30, having coil ends 32 and 34 terminating in a bonding area to which the flip chip is attached, similar to that described above. An insulating layer 36 is provided in the crossover area and over which a crossover conductor 38 extends from the outer coil turn to the bonding area. The coils are positioned on the substrate in substantially the same pattern as the aforementioned PTF design shown in FIG. 2. In this embodiment the coil is formed by etched copper printed circuit techniques. The insulating layer in the cross over area is printed using a dielectric PTF ink and this layer may be multiply printed to provide a sufficient dielectric thickness. The crossover conductor is printed using a silver filled conductive PTF ink. The flip chip assembly process is substantially the same as noted above, except that the time, temperature and pressure bonding parameters are set to accommodate the differences between the copper and PTF conductors.

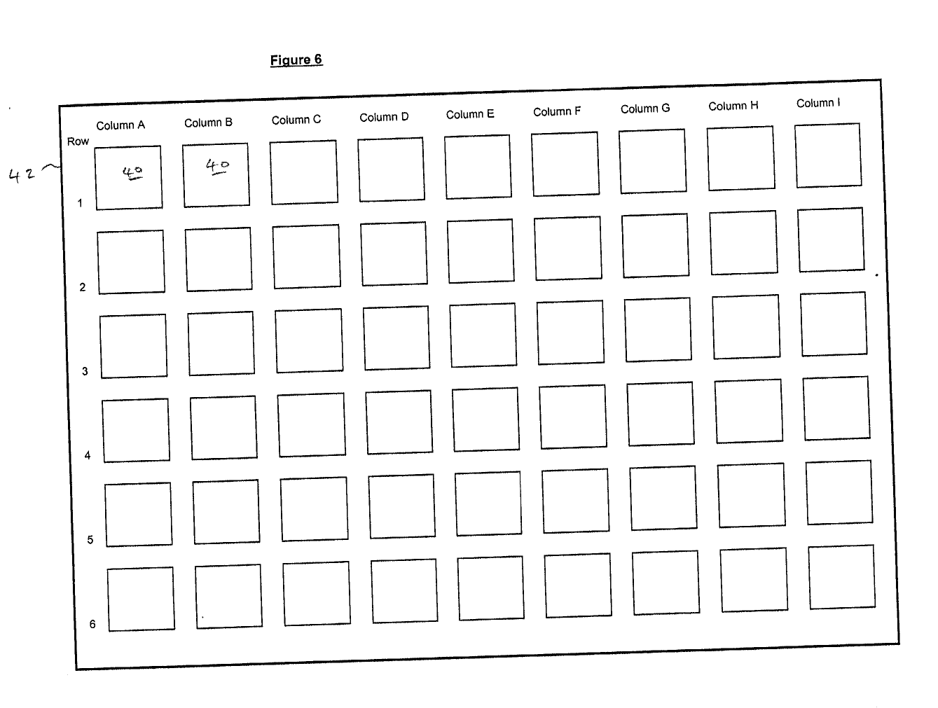

In another typical embodiment, the same chip referenced in FIG. 1 is attached to an antenna coil which is nominally 2×2 inches. FIG. 6 shows 54 of the antenna coils 40 laid out on the substrate 42 in a 9 by 6 array. This circuit fabrication process and the flip chip assembly process are substantially the same as those described for the circuit in FIG. 1, with a few noted differences. The ink printing screens, ACP printing stencil, assembly programs and bonding tooling are unique to each layout. With the greater number of circuits per image group, both the fabrication and assembly through-put rates will be higher for the 2×2 inch design.

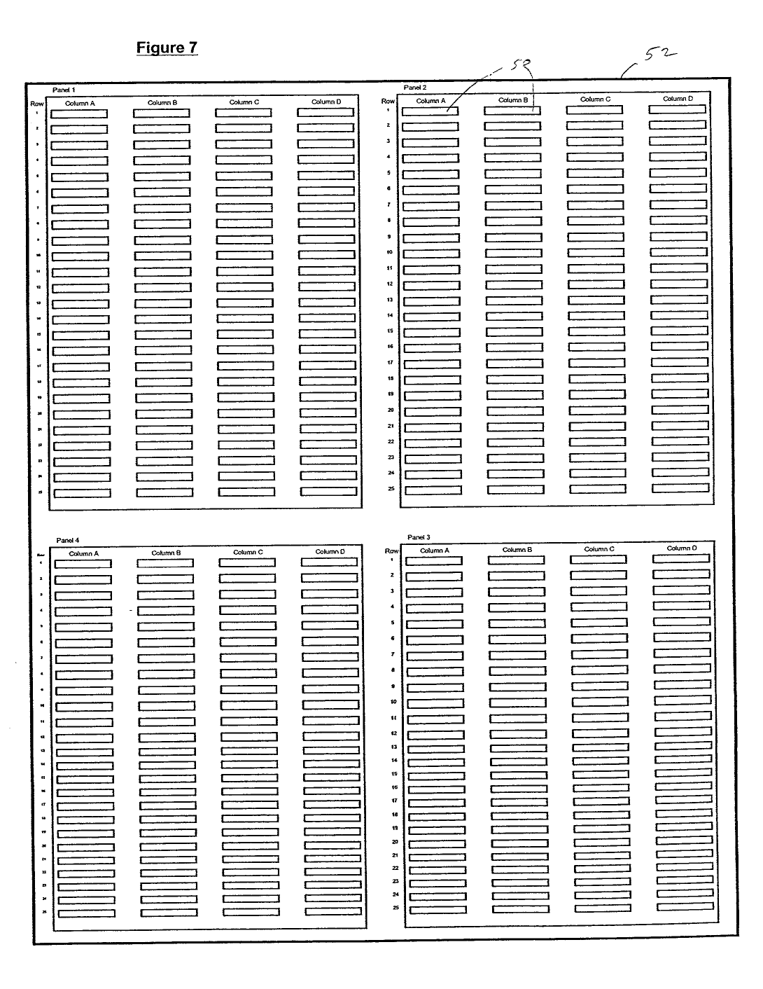

In yet another typical embodiment, another type of RFID chip is attached to a small format dipole antenna, measuring approximately 0.3 by 1.7 inches. FIG. 7 depicts the array of 400 antenna & chip locations 50 on a 18×24 inch substrate 52. This circuit is fabricated by printing and curing conductive PTF ink followed by printing a protective dielectric layer. With the dipole (as opposed to coil) design, no crossover is required. The flip chip assembly process is substantially the same as described for the previous examples, with a few noted differences. The ACP printing stencil, assembly programs and bonding tooling are unique to each layout. With the 400 circuits per image group, both the fabrication and assembly through-put rates will be higher than the previously mentioned designs.

It will be appreciated that the assembly process can be used with a variety of circuits or circuit patterns. A variety of electronic components other than flip chip devices can be assembled with the invention. The process may be practiced with a substrate in sheet or roll form.

Providing a plurality of circuits in a relatively wide are format permits a large number of circuits to be processed at a time, and the large format provides great flexibility in the size and shape of circuits that can be assembled. The Anisotropic Conductive Adhesive can be printed in the large area format in a short period of time using commonly practiced screen printing or stencil printing techniques. The time to print ACP on many die locations over a large format area in a single pass is shorter than serially dispensing Anisotropic Conductive Film. When changing from one product to another, only a single stencil or screen need be changed which adds to the flexibility of the present invention over the known ACF techniques.

Both thermosetting and thermoplastic ACP's have been successfully employed. These materials may be dried or partially cured (B-stage cured) prior to assembly of the chip.

Commercial pick and place machines, normally used for assembly of Surface Mount Technology (SMT) devices, have been used to place flip chip devices in conjunction with the current invention. The chips have been presented to the pick and place machine in a tape & reel format, or by a feeder that picks the die directly from the wafer in which Integrated Circuits (IC's) are fabricated. The pick & place machine is operative to place the die anywhere within the image group, requiring changing of a software program only to change the layout.

A bonding press is employed to provide intended temperature and pressure to cure the paste and bond the chips in place on the circuit. The bonding press accepts the entire substrate and includes a base having a heater plate which is electrically heated to an intended temperature. An insulation layer is provided over the heater plate and onto which the substrate is placed. A plurality of thermally conductive inserts are disposed through the insulation layer in positions aligned with the bonding sites of the substrate and which act as heat conductors from the heater surface to the bonding sites. Heat is applied only to the component locations while the rest of the substrate remains relatively cool, thereby minimizing any heat distortion effects. The upper plate of the press includes a tooling plate containing dowel pins at locations aligned with the chips of the circuit. The bonding pins applied the intended bonding pressure on the chips when the press is closed. The intended weight can be effected by using the weight of the bonding pin only, the weight of the bonding pin in conjunction with a discrete weight mounted on the pin, or a spring or pneumatic force applied to the pin. The tips of the pins in contact with the component may contain a non-stick surface such as Teflon. The press is opened and closed by a piston mechanism.

The bottom section of the press applies heat to the substrate to cure the ACP. The top section of the press applies pressure to the chips and underlying adhesive and substrate during the curing cycle. The bonding force is typically in the range of 10-200 grams. The platen is heated to a set point such that the desired bonding temperature is present at the surface of the bonding pins. The typical platen set temperature is 100-180° C., depending on the attachment adhesive. The bonding pins remain in contact with the dies for a dwell time of typically 5-40 seconds, depending on the ACP, chip and circuit materials.

The bonding press is designed to have a flexible sequence during the cycle. For example, contact to the substrate & chips may be made by the bottom section first, the top section first, or the top and bottom section simultaneously. Similarly, at the end of the bonding cycle, the retraction of the tooling from the circuit may happen in multiple scenarios—bottom section first, top section first, or top and bottom section simultaneously.

The bonding pins may be non-heated, heated internally or pre-heated by the bottom section. The bottom heating section may employ a variety of thermal technologies to heat the product—conduction, convection, infra-red, ultraviolet, etc. The insulating layer may be comprised of an insulating material, a reflecting material or a gaseous barrier. Liquid cooling of the insulating layer may be also employed.

The novel process provides a throughput of about 10-14 thousand components per hour. This is in comparison to normal flip chip assembly processes which have a throughput of 1-3 thousand components per hour. The use of an Anisotropic Conductive Paste reduces the number of process steps in relation to that needed for isotropic adhesives in that no underfill is required. The bond times are sufficiently low as to not interfere with the high speed operation of standard pick and place machines. The high speed is achieved by processing a large work area or image group in order to be compatible with the high speed placement systems. The use of printed Anisotropic Conductive Pastes is substantially more efficient than the known Anisotropic Conductive Films which must be cut and applied to individual locations, a process which is time consuming and which adds considerably to overall process time. The circuits shown above in FIGS. 1 and 5 can be processed over 9,000 circuits per hour for 36 circuits on an 18×24 inch substrate. The circuits shown in FIG. 6 can be processed over 10,000 circuits per hour. The circuits show in FIG. 7 can be processed over 15,000 per hour.

Additional process steps can be optionally employed depending on the application and materials used. When a thermosetting adhesive is used it is typically printed as a liquid and then cured to a solid state during the bonding step. In some applications it may be desirable to partially cure the adhesive, known as a B-stage cure, prior to assembly in order to have it a more rigid adhesive prior to bonding. Alternatively, when a thermoplastic adhesive is used, it is also printed as a liquid but solvents should be dried from the adhesive prior to the bonding step. The adhesive may be fully cured during the bonding process, or in order to reduce the bonding time, the adhesive may be partially cured during the bonding process and then completely cured during a post cure operation. Some applications required an encapsulant or “glob top” to be dispensed over the die to enhance mechanical and environmental reliability. The dispensing and curing operations can be part of the flip chip assembly process.

It will be appreciated by those of skill in the art that the invention can be practiced with a variety of materials, techniques and production equipment. For example, the substrate can be of many types of printed circuit materials such as PET, PEI, PEN, PI, PBT, PVC, ABS, paper, polycarbonate, PTFE and epoxy/glass. The substrate may be rigid or flexible and may be in sheet or roll form The substrate may also be clear, translucent or opaque. The conductive patterns may also be provided on both surfaces of the substrate for circumstances where double sided printed circuit are useful.

While ACP has been described in the preferred embodiments as an attachment adhesive for the chips or other components, for some purposes the attachment adhesive can be a Non Conductive Paste (NCP). The attachment adhesive can be printed with commercially available stencil or screen printing machines and the thickness of the adhesive is provided to suit the particular substrate, conductors, component dimensions and contact type, size and configuration.

The electronic component attached to the printed conductive patterns can be of the flip chip type as noted above in which the active side of the chip is facing down on the substrate. The chip may also be mounted with the active side up for some purposes. The electronic component can be of surface mount (SMT) format or may be a leaded device.

Components may be placed on the substrate by known pick and place machines. The components may be supplied to the machine in any convenient manner. The bonding press can provide heat locally to each component location while insulating other portions of the substrate across the image group. Alternatively, heat can be applied to the entire substrate area. Force is applied to each of the components by means of bonding pins and with the bonding force being determined by springs or weights associated with the pins.

The assembly process may be implemented with variations in the sequence of steps to suit particular materials and operational requirements. As an example the process can comprise printing the attachment adhesive, placing the electronic components and bonding the components which includes curing of the adhesive. Alternatively, the adhesive can be dried or B-staged cured before placement of the components, and with a final cure of the adhesive during or after bonding. As noted above, an encapsulant or “glob top” may be dispensed over the electronic device after the bonding or final curing operations. After the assembly process is completed, the circuits may be tested following which the circuits may be individually cut from the substrate. If a roll form of substrate is employed, the substrate may be slit into intended widths and wound into a reel for shipment and/or use.

The invention is not to be limited by what has been particularly shown and described, and is intended to encompass the spirit and full scope of the claims.

1. A method of fabricating antenna circuits comprising the steps of:
printing one or more layers of a conductive polymer thick film ink on a substrate in an intended antenna coil pattern having an inner coil end and an outer coil end;
curing the conductive polymer thick film ink;
printing one or more layers of an insulating material in a crossover area of the antenna coil pattern between the outer end of the antenna coil and a bonding area near the inner end of the antenna coil;
curing the insulating material;
printing one or more layers of conductive polymer thick film ink on the insulating material in a path between the outer end of the antenna coil and the bonding area; and
curing the conductive polymer thick film ink on the insulating material.

2. The method of claim 1 wherein the conductive polymer thick film ink includes an adhesive binder filled with silver particles.

3. The method of claim 1 wherein the conductive polymer thick film ink has a resistivity less than or equal to 10 milliohms per square mil.

4. The method of claim 1 wherein the conductive polymer thick film ink is thermosetting.

5. The method of claim 1 wherein the conductive polymer thick film ink is thermoplastic.

6. The method of claim 1 wherein the antenna coil pattern is printed in multiple layers of conductive polymer thick film ink.

7. The method of claim 6 wherein the thickness of each conductive polymer thick film ink layer is in the range of 5 to 30 microns.

8. The method of claim 1 further including:
applying an attachment adhesive to the bonding area;
placing an electronic component on the bonding area in engagement with the attachment adhesive; and
applying an intended temperature and pressure for a duration sufficient to cure the adhesive and form a mechanical and electrical bond between the component and coil.

9. An antenna circuit formed by the method of claim 1.

10. An antenna circuit formed by the method of claim 8.

11. A method of assembling electronic components on a substrate containing a plurality of electronic circuits located within a large area image group on the substrate, the method comprising the steps of:
printing an attachment adhesive in unison on a plurality of connection points on the substrate associated with the plurality of electronic circuits;
placing electronic components on respective locations of the plurality of component locations within the image group; and
simultaneously bonding all of the components by applying an intended temperature and pressure for a duration sufficient to cure the attachment adhesive to form a mechanical and electrical bond between the components and circuits.

12. The method of claim 11 wherein the attachment adhesive is an Anisotropic Conductive Paste.

13. The method of claim 11 wherein the attachment adhesive is a non-conductive paste.

14. A method of fabricating electronic circuits comprising the steps of:
providing a substrate of electrically insulating material;
providing a plurality of conductive patterns on the substrate each representing at least a portion of a respective circuit;
providing a plurality of bonding areas on the substrate associated with respective conductive patterns;
applying a conductive ink to the conductive patterns to provide respective conductive paths from a portion of the respective conductive pattern to respective bonding areas;
applying an anisotropic conductive paste in unison to the bonding areas;
applying a plurality of electronic chips to the respective bonding areas in contact with the paste; and
applying in unison heat and pressure to the chips for a time sufficient to cure the paste and bond the chips to the bonding area.

15. The method of claim 14 wherein the step of applying heat and pressure includes:
applying heat to the substrate and pressure only to the chips to bond the chips to the bonding area.

16. An electronic circuit fabricated by the method of claim 14.

17. The method of claim 14 wherein the step of applying a conductive ink comprises printing with a conductive ink.

18. The method of claim 17 wherein the step of providing a plurality of conductive patterns comprises printing with a conductive ink.

19. A method of fabricating antenna circuits comprising the steps of:
printing one or more layers of a conductive polymer thick film ink on a substrate in an intended path having an inner end and an outer end;
curing the conductive polymer thick film ink;
printing one or more layers of an insulating material on the path;
curing the insulating material;
printing on the substrate one or more layers of a conductive polymer thick film ink in an antenna coil pattern having an inner coil end and an outer coil end in contact with the respective inner and outer ends of the path; and
curing the conductive polymer thick film ink of the antenna coil patterns.

20. A method of fabricating antenna circuits comprising the steps of:
printing one or more layers of a conductive polymer thick film ink on a substrate in a plurality of antenna coil patterns having an inner coil end and an outer coil end to provide a plurality of antenna coils on a substrate surface;
curing the conductive polymer thick film ink;
printing one or more layers of an insulating material in crossover areas of the antenna coil patterns between the outer end of the respective antenna coils and respective bonding areas near the inner end of the respective antenna coils;
curing the insulating material;
printing one or more layers of conductive polymer thick film ink on the insulating material in respective paths between the outer end of the respective antenna coils and the respective bonding areas; and
curing the conductive polymer thick film ink on the insulating material.

21. A method of assembling electronic components on a substrate containing a plurality of electronic circuits located within a large area image group on the substrate and having a plurality of electronic components attached by an adhesive to selected positions on the circuits, comprising:
placing the substrate and electronic components in a bonding press having a heater for heating at least the electronic component positions of the substrate and a plurality of pins for engaging respective electronic components and providing predetermined bonding force thereon; and
applying an intended temperature and pressure by the bonding press to the substrate and electronic components to cure the adhesive and form a mechanical and electrical bond between the components and circuits.
